(19) United States
(12) Patent Application Publication
(10) Pub. No.: US 2009/0051561 A1
(43) Pub. Date: Feb. 26, 2009

(54) System and Method For Advertising Display

(76) Inventor: Steven Cadavid, Bay Harbor, FL (US)

Correspondence Address: ROBERT M. SCHWARTZ, P.A., P.O. BOX 221470, HOLLYWOOD, FL, 33022, US

(21) Appl. No.: 12/197,399

(22) Filed: Aug. 25, 2008

Related U.S. Application Data
(60) Provisional application No. 60/957,775, filed on Aug. 24, 2007.

(51) Int. Cl. G08B 5/00; H04N 7/025

(52) U.S. Cl. 340/691.6; 725/32

(57) ABSTRACT

The present invention is a system and method for advertising using a portable media display unit that displays video from information stored on a media display unit or information transmitted wirelessly to the unit.

### INDEX TO RELATED APPLICATIONS

This application claims the benefit of U.S. Provisional Application No. 60/957,775 filed Aug. 24, 2007, the disclosure of which is incorporated herein by reference in its entirety.

### BACKGROUND OF THE INVENTION

Advertising is a technique routinely used by companies to attract potential customers to their products. It is performed by a vast number of entities on a regular basis all around the world. There are several established methods by which to broadcast advertisements to the public. This invention primarily focuses on impacting the way advertising can be done in an outdoor and/or indoor public marketplace setting. Current outdoor and indoor public marketplace advertising mediums can be categorized into three principle classes based on the quantity of people exposed to it—1) long-range, 2) medium-range, and 3) short-range. Long-range mediums consist of roadside billboards and aerial-based displays. The advantage to long range mediums is that they have a large exposure range, which means that they can potentially be seen by a large quantity of consumers at any given time. However, the disadvantage is in their limited ability to convey information dynamically. Short range mediums include wall-mounted displays such as posters and backpack-based displays such as those described in the upcoming section. The primary advantage to short-range mediums is that they are lightweight and can be portable. They can also provide a level of personability in the sense that the consumer must approach the medium in order to obtain its information. Medium-range mediums come in the form of automotive-based displays. The advantages are in its mobility and exposure range. These mediums are a compromise between the long range and short range mediums. Although they are not large enough to have a high exposure at any instant, they travel fast enough that they can be seen by medium quantities of consumers spread across a large region in a short period of time. Medium-range forms can also have the advantage of displaying information dynamically such as in a television display mounted on the side of a truck. However, their disadvantage lies in their inability to provide personability due to their confinement to the roadways. The present invention is a novel medium-range system that eliminates the shortcomings of traditional medium-range mediums and increases the strengths associated with short-range mediums.

### SUMMARY OF THE INVENTION

The present invention relates to a visual-audio display and a method of advertising, marketing, or giving visual and audio information in a unique manner. More particularly, the present invention is directed towards an assembly or a back pack of the type that may be displayed exteriorly above the head of the wearer. A display having a screen situated on the torso of the wearer will have a line of sight greatly reduced because people will block the screen. The present invention has a screen situated above the height of most persons, such that even when traversing densely populated crowds, many people will have a direct line of sight with the screen because the screen is not obstructed. Screen or video display, as used herein refers to any suitable video display device that may include, but would not be limited to, cathode ray tube (CRT), liquid crystal display (LCD), organic light emitting diode display (OLED), and similar video display technologies.

In one embodiment, the present invention is a system for conveying visual messages having:
a. a media unit with an electronic video display of at least about 12 inch width having an input for receiving video display information and a surface for viewing video from said input;
b. a support for said video display;
c. a harness connected to said support suitable for wearing by a standing or walking person;
d. a source of electricity for said video display;
wherein said display is viewable from a distance at least 10 feet from said display.

The video display may include, but would not be limited to, CRT, LCD, plasma, OLED, or any combination thereof. The system has an input for receiving video display information stored on a computer readable medium. Alternatively, the system input for the video display information is transmitted wirelessly to the video display. The input for receiving video display information is received as video display input and said input is output as a visual image viewable on the video display.

The system also has a support that extends upward from a harness. Ideally, the support holds said video display between about 6-10 feet above the ground.

The harness is worn on the upper torso of a person, preferably worn on the shoulder of a person.

The system has a source of electricity which may be battery, solar power, or any other electricity source.

The system weighs less than about 100 pounds and preferably less than 75 pounds.

The system also includes a camera for tabulating information relating to the number of persons viewing said video display.

Also contemplated is a method of advertising with the steps of:
a. connecting a media unit with a video display of at least about 12 inch width having an input for receiving video display information and a surface for viewing video from said input to a support;
b. connecting said support to a wearable harness;
c. placing the harness on a wearer;
d. initiating input to said video display such that input generates images on said video display;
e. having a wearer stand or walk such that said video display on said support is about 6-10 feet above the ground.

The method further includes use of a camera such that the camera and computer record information relating to persons viewing said images on said video display.

The method also provides a harness that has legs that support the unit when unharnessed from a person.

In the method of the present invention the video display is generated from information stored on computer readable media on said display unit or is transmitted wirelessly to said display unit.

### BRIEF DESCRIPTION OF THE FIGURES

FIG. 1 is a perspective view of the video display of the present invention shown mounted on a user.

FIG. 2 is a front view of the video display of the present invention.

FIG. 3 is a side view of the video display mounted on a stationary tripod.

FIG. 4 is a side view of the video display.

FIG. 5 is a rear view of the video display.

FIG. 6 is a front view of a harness for holding the video display.

FIG. 7 is a schematic of the power, audio, and video components of the system of the present invention.

### DETAILED DESCRIPTION OF THE PREFERRED EMBODIMENTS

Media unit assembly 10 has frame assembly 20. Frame assembly 20 has a harness assembly 80 for attachment to the body of a person. Frame assembly 20 has an electronics casing 22, power supply 26, and power regulator 28. Frame assembly 20 further supports a computer 38 within electronics casing 22, that is operatively connected with audio system 42 controlled by audio switch 44 and video switch 46 that controls video display 48. The system encompasses gaze detection camera 50. Gaze detection camera 50 is preferably positioned on video display 48 by may be positioned in any appropriate position and is shown on the top of video display 48 for illustrative purposes only.

The system of the present invention may include a remote transmitter 24 which is any appropriate computer or electronic device for wireless transmission of information from transmitter 24 to media receiver 36. Media receiver 36 is integrally associated with media unit assembly 10.

Frame assembly 60 supports video display 48 with a pair of video display upper supports 75 that are connected to electronics case 22. Electronics case 22 is pivotably connected with pivot screw 62 on either side of electronics case 22 at upper leg 72. Each upper leg 72 is attached to middle leg 74 and lower leg 76.

Video display 48 is slidably movable in a generally vertical manner along a pair of video display lower supports 77 in a male-female interlocking relationship as shown in FIG. 3. Video display lower supports 77 having a generally male interlocking configuration slides within video display upper supports 75 with a female interlocking configuration and video display 48 is secured into a fixed position with a spring plunger lock 78 that simultaneously engages corresponding locking cavities vertically positioned on the outside edge of each of video display upper supports 75 and video display lower supports 77.

Media unit assembly 10 has an equipment mounting plate 110. Power cable 114 extends outward from electronics casing 22 at cable connector 116.

In one embodiment, media unit assembly 10 may additionally include display region 112 for providing additional surface for display of information.

The present invention includes harness assembly 80 for a person to wear and walk to transport media unit assembly 10. Harness assembly 80 includes a pair of straps 82 that are adjustable at a pair of buckles 84. Each strap 82 has a terminal end with a pair of ring connectors 86. Each strap 82 is constructed and arranged to be positioned at both the upper and lower edge portions of harness assembly 80.

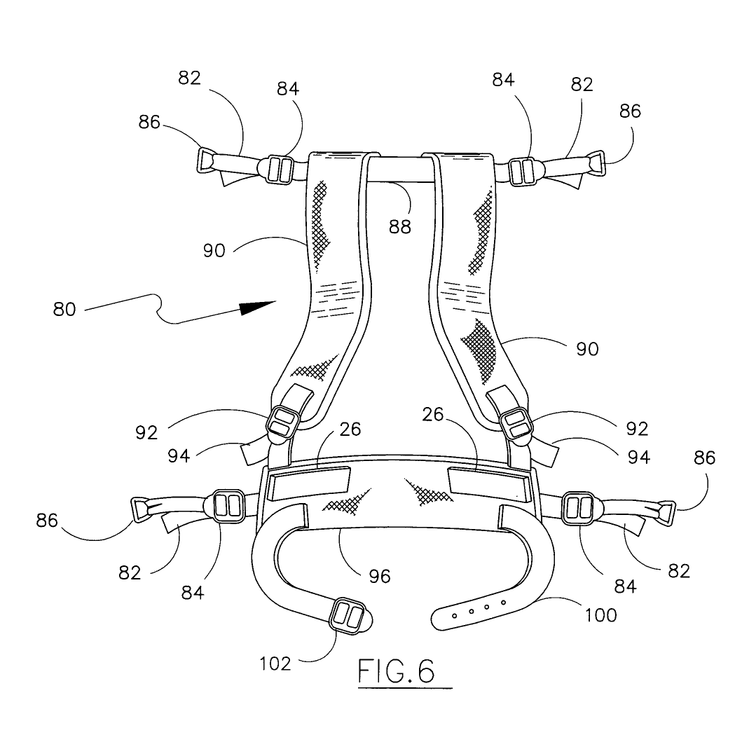

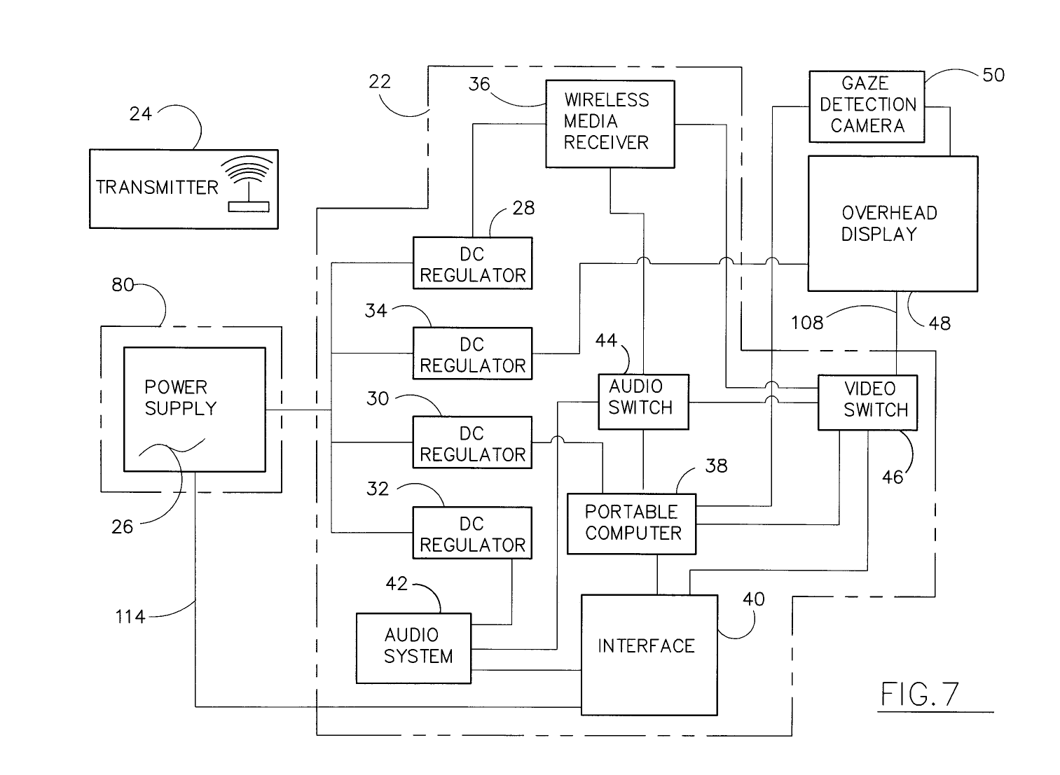

Harness assembly 80 includes a pair of shoulder straps 90 that connect to belt 96 by a pair of shoulder strap connecting straps 92 that may be adjusted by a pair of connecting strap buckles 92. Belt 96 may have one or more power supplies 26 incorporated thereon, as shown in FIG. 6.

The present invention is an advertising display system and methods of advertising. Video display 48 is preferably a liquid crystal display (LCD) mounted atop harness assembly 80. The system and method of the present invention conveys either audio, video, or audio-video messages to the public using the video display 48 which is both dynamic and portable. The system of the present invention is constructed and arranged to provide a mechanism for broadcasting advertisements and information. The system has media assembly 10 and will have a video display 48 secured on a frame.

In one embodiment, frame assembly 20 is attached to a wearable harness assembly 80. Media assembly 10 is constructed and arranged to receive video display information from either an internal media unit utilizing computer 38 mounted on frame assembly 20 or may receive video display information transmitted from an external transmission unit 24 located at a remote location and likely some distance away. Transmission unit 24 sends wireless information that is received by receiver 36 operatively connected with media unit assembly 10 and computer 38. The transmission of information may be by any acceptable means and may include but would not be limited to transmission by a computer, cell phone, smart phone, Personal Digital Assistant (PDA), or any other apparatus capable of wirelessly transmitting video and/or audio information to media assembly 10. Each of the video display 48 and the receiver 36 will be powered by a battery 26 which may be located anywhere on media unit assembly 10. In one embodiment battery 26 is mounted on frame assembly 20.

A video stream will be sent or fed to display 48 via a High-Definition Multimedia Interface (HDMI) to single-Digital Visual Interface (DVI) converter. The system and method of the present invention provides a novel system in having the capability to broadcast dynamic information from a medium-sized display, which is mounted overhead the body of a person, in a mobile fashion with each of (1) the incorporation of a quad-pod frame structure assembly 60 for free standing (unmanned support), (2) a self-contained encasement media assembly 20 with peripheral interface, (3) an automatic gaze detection device 50 and a demographic extractor coupled with a GPS device, and (4) a height adjustable overhead display supported on harness assembly 80.

In one embodiment, the media unit assembly 10 either displays video on display 48, produces audio through audio system 44 or a combination of both. The display information is provided to the media unit assembly 10 by way of information operatively associated with computer 38. The operative information transmitted from computer 38 may be by any acceptable means and may include, but would not be limited to media information stored on a hard drive or on removable media such as a flash drive that is contained within electronics casing 22. Preferably, the information has a pre-recorded message.

In one embodiment, media unit assembly 10 may receive audio and video display information sent by a transmitter 24 located a distance away that will transmit signals to an antenna of receiver 36 located anywhere on media unit assembly 10 and operatively associated with each of computer 38, audio system 42 and video display 48. Video display 48 may be any acceptable video display that may include, but would not be limited to liquid crystal display (LCD), organic light emitting displays (OLED), and the like.

The signal sent by transmitter 24 is preferably encrypted upon transmission from transmitter 24 and decoded upon receipt by receiver 36, thus providing a secure means of communication. The system and method of the present invention additionally contemplates having transmitter-receiver communications with several devices in use simultaneously. Instead of producing the same message locally from the portable computer of each device, transmitter 24 can broadcast the media feed, which will be received by the receiver 36 and subsequently channeled to each of respective media units 10. Thus, there may be multiple unit assemblies 10 receiving information from a single transmission from transmitter 24.

A pair of portable batteries 26 are connected in parallel, and are positioned on either side of belt 96. Conventional electrical wires will connect the batteries to computer 38, video display 48, and all components in media unit assembly 10 that require power. Preferably, batteries 26 are connected to a DC-to-AC inverter, and the output of the inverter is then connected to the display. This configuration allows use of standard AC plug to power the display. However, this is an inefficient method for connecting a battery to a display because the display itself must convert from AC back to DC before powering. In other words, using an inverter will produce the following conversions: DC-to-AC and AC-to-DC. Ideally, the connection between the battery and display should be DC-DC conversion only, which is done using a DC regulator. Likewise, all components in the computational unit will include a DC regulator to convert the DC power to its power specifications.

The term ergonomic, as discussed herein, refers to design factors intended to maximize productivity by minimizing operator fatigue and discomfort.

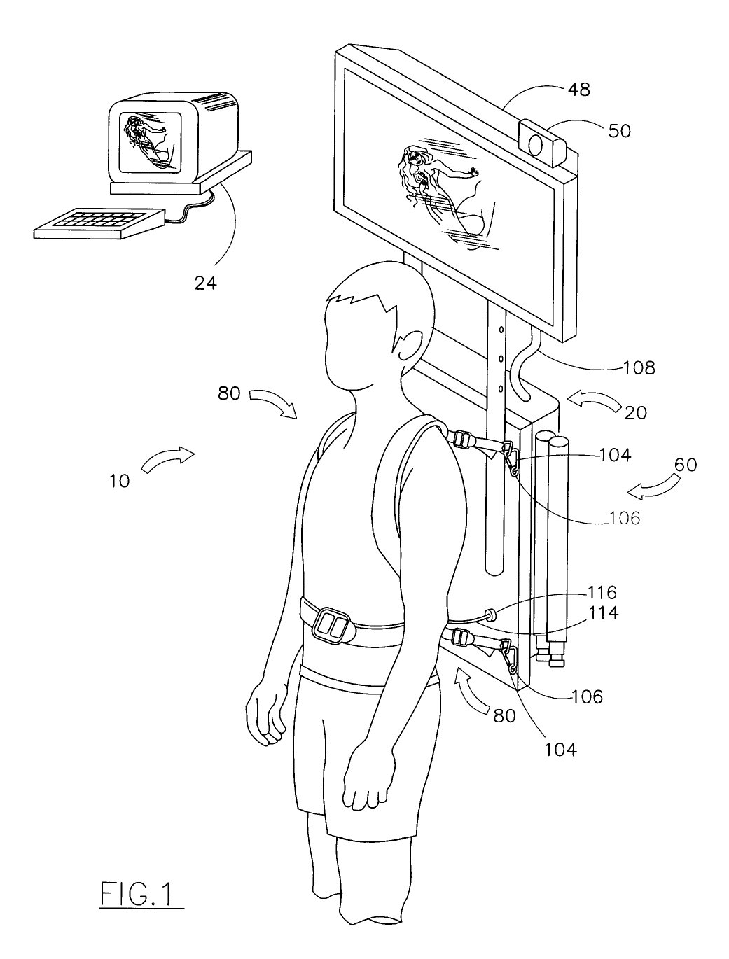

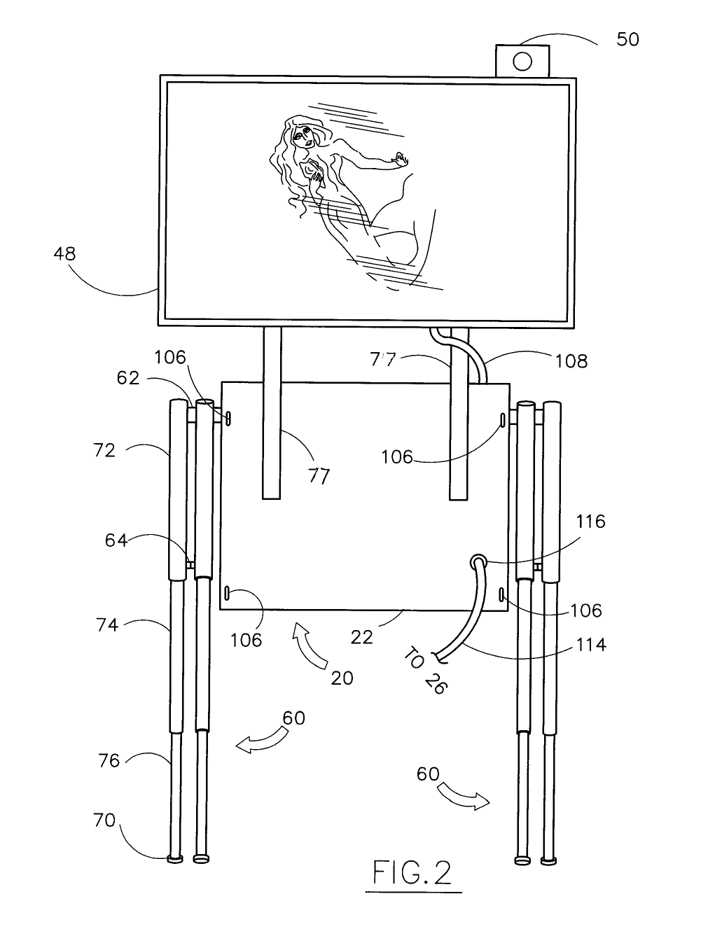

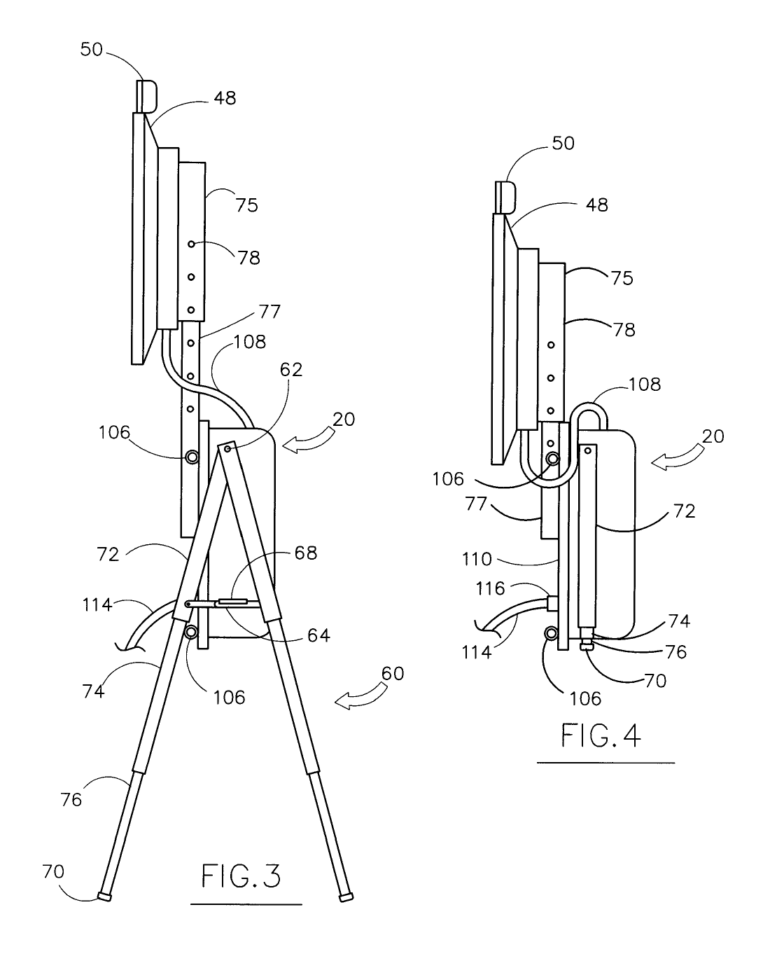

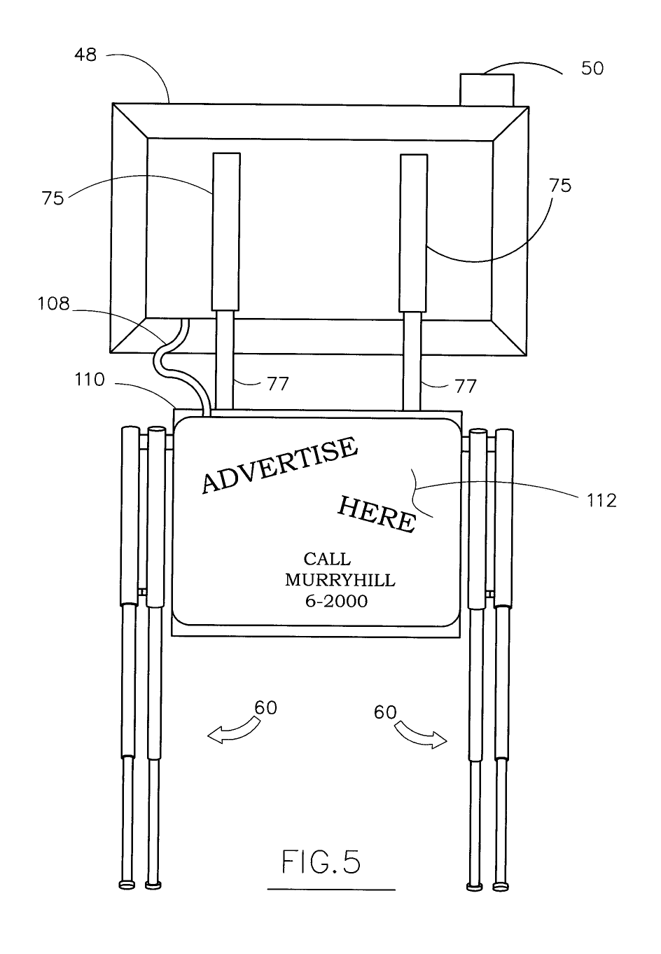

The system and method of the present invention has a frame pack assembly 20 constructed and arranged to provide an ergonomic design. The ergonomic design allows the accumulated weight of media unit assembly 10 to be evenly distributed across a person's body when media unit assembly is worn by a person as shown in FIG. 1. Video display 48 is height adjustable. The height adjustment of video display 48 can be configured for maximum display to surrounding onlookers. Video display 48 is preferably at a height of 6-10 feet above the ground. When a person wearing media unit assembly 10 on harness assembly 80 walk on a city street, other persons will be able to view video display 48 above the height of most other person located nearby.

Media unit assembly 10 may be disengaged from a person and be a free-standing unit as shown in FIG. 3. In this configuration, the operator may disengage from media assembly 10 and media assembly 10 will continue to function in a fixed location.

A quad-pod structure having four telescopic legs, each telescopic leg having upper leg 72 attached to middle leg 74, and middle leg 74 attached to lower leg 76. The top portion of upper leg 72 is pivotably attached to side of electronics case 22 at pivot screw 22. When it is desired to carry media assembly 10, the telescoping legs will be retracted. When media assembly 10 is unmanned and free-standing, the telescoping legs 72, 74, and 76, will be placed in their extended position, as shown in FIG. 3 and fixed using a locking mechanism built into each leg as is commonly known in telescoping locking mechanisms. Stand assembly 60 has a pair of corresponding locking hinges 64 and locking bars 68, similar to conventional ladders, positioned between each of upper legs 72 that will lock stand assembly 60 into position.

Media unit assembly 10 incorporates a peripheral interface, similar to that of a conventional computer, on the outside electronics case 22. This interface may include, but is not limited to, USB ports, a power button, a battery charging port, volume knob, media source switch, and an additional video output (e.g. VGA and S-Video). This will allow for user control and accessibility of media unit assembly 10 component parts without having to open electronics case 22.

Audio speakers, as are commonly known, may be contained on or within electronics case 22 and/or on or within video display 48. Electronic case 22 may have either one or two multimedia sources. A first source is computer 38 that has both an audio and video source and supplies information to each of the audio system 42 and video display 48, respectively. Using computer 38 gives the added benefit over a conventional media player (e.g. DVD player) of having interactive capabilities. Advertisements need not be produced prior to using the system (e.g. DVD disc compilation), as they can be created on-the-fly using installed video editing software and presentation tools (e.g. Microsoft PowerPoint, Microsoft Corporation, Redmond, Wash.). A second multimedia source is the wireless receiver 36 previously discussed. Each of computer 38 and receiver 36 can be used interchangeably through the use of a switch that can be controlled from the peripheral interface.

The system and method may include having employed carriers walk one of multiple routes displaying commercials and advertising from different businesses. The businesses will be charged for the amount of time they want their commercials to appear on video display 48. Also, businesses may be charged differently according to the route they choose for their commercial display. A route that includes streets that are very populated and well-traveled would cost more than a route that consists of less populated and well-traveled streets. Likewise, the time slots that are chosen to advertise will also differ in price. Hours that are known to possess a greater number of people in an area would be more expensive than hours that have less people populating the area. The system and method includes the capability of wirelessly changing the audio and/or video such that the person carrying media assembly 10 need not stop in order to change the advertisement. The change in advertisement will occur without the person carrying media assembly 10 to perform any action.

The system and method of the present invention further encompasses the capability of determining the frequency and volume of pedestrian traffic for a single area at a given time. The system can detect and analyze on-coming pedestrians that make eye contact with the overhead display. Eye contact will be determined using a camera 50 or plurality of cameras, with zooming capability, and an automatic gaze detection algorithm that will first coarsely but quickly localize the eye regions on the faces of on-coming pedestrians. This real-time algorithm will then direct the camera to zoom in on the detected eye regions. Then, the iris and pupil will be localized, and the gaze direction can then be formed. On-coming pedestrians that the algorithm determines to be making eye contact with the overhead display are classified as provisional candidates demonstrating interest in the currently displayed advertisement. There is a minimum amount of time necessary for an individual to be gazing at an event before the individual is declared as having placed their attention on the event. Persons that maintain their gaze on the overhead display for a time period greater than or equal to a predetermined time threshold are retained while all others are discarded. A counter will automatically increment each time an on-coming pedestrian is determined to be an individual placing attention. Counters will be created as per advertisement basis. This will enable the system to keep a running count on the number of individuals who viewed a given advertisement. Individuals who are detected as having placed their attention then undergo automated demographic analysis.

The system may further use camera 50 to record information such as skin detection and facial feature analysis of persons viewing advertisements on video display 48. Algorithms will determine the age, gender, and ethnicity of persons viewing advertisements on video display 48.

The gaze detection system is capable of detecting and analyzing on-coming pedestrians that make eye contact with the overhead display. Eye contact will be determined using a web camera (or plurality of web cameras, with zooming capability) and an automatic gaze detection algorithm that will first coarsely but quickly localize the eye regions on the faces of on-coming pedestrians. This real-time algorithm will then direct the camera to zoom in on the detected eye regions. Thirdly, the iris and pupil will be localized, and the gaze direction can then be found.

Face Detection

To facilitate the localization of the eye regions of on-coming pedestrians, the system will first apply face detection. The face detection system uses the concept of an integral image and the AdaBoost algorithm from machine learning to obtain fast detection of faces in a video frame. AdaBoost is short for Adaptive Boosting, is a machine learning algorithm

A random guess on a question that can have one of two answers has a 50% probability of being correct. A heuristic can improve the probability of a correct answer by a small amount it is known as a weak classifier. Similarly, a heuristic that can improve the probability of a correct answer by a significant amount is known as a strong classifier. Boosting sets out to combine a series of weak classifiers to generate a single strong classifier, while providing statistical bounds on the training and generalization error on the algorithm.

The weak classifiers in the proposed algorithm are based on three types of features. The first feature type, a two-rectangle feature, is the difference between the sum of the values of two neighboring rectangular windows. The second feature type, a three-rectangle feature, accounts for three neighboring rectangles and computes the difference between the sum of the pixels in the wing rectangles and the sum of the pixels in the middle rectangle. The third feature type, a four-rectangle feature, accounts for a 2×2 set of rectangles and computes the difference between the sum of pixels in the rectangles that represent the main and off diagonals. For a 24×14 subwindow there could be more than 180,000 such features. The purpose behind using the AdaBoost algorithm is to select a few hundred features and assign weights to each, where weights are trained using a set of images. Face detection is reduced to computing the weighted sum of the chosen rectangle-features and applying a threshold.

Computing rectangle features is a simple but slow operation because it requires summing pixel values between neighboring rectangular regions. Moreover, recomputing these sums for each pixel location is computationally expensive. The sum of the pixels in the rectangular region can be computed easily using an intermediary representation known as an integral image. The integral image value at pixel location (x,y) in an image is defined as the sum of all pixels to the left and above the pixel (x,y). Given the integral image, computing a feature F reduces to:

$$S = {\sum }_{i = 1}^{9} W [ i ] \times IntegraImage [ F . Index [ i ] ]$$

$$F . score = abs ( S - F . mean\_face ) < abs ( S - F . mean\_nonface )$$

where W is a set of known weights that depends only on the feature type being computed. F.Index is a set of indices denoting connections to specific locations within the integral image that are trained for each selected feature. F.mean_face denotes the average distance from a feature F to the set of rectangles known to contain faces. Similarly F.mean_nonface denotes the average distance from feature F to the set of rectangles known not to contain faces. Thus the score of the feature F is contingent on whether it is closer to rectangles known to contain faces rather than those known not to. The decision of whether or not an image window contains a face is based on the following equation:

$$IsFACE = {\sum }_{i = 1}^{N} F [ i ] . score > threshold$$

Now, with a face detected in a video frame, and zooming into this region of interest, head pose can be roughly determined. 3D head pose is determined by using the vanishing point in the image formed by the intersection of the eye-lines and mouth-line. These lines are obtained by using the Canny edge detection along with a series of binary morphological operations.

Iris Detection

The most prominent and reliable features within the eye region are edges of the iris. The system and method of the present invention detects the iris edge (bright-to-dark and dark-to-bright step edge) using a (3×3) vertical edge operator, which detects and emphasizes vertical edges, and a (3×3) morphological “open” operation. Since the 3D position of the corners of the eyes are already known in pose determination used in the present invention, the location of the eye corners in the gaze image are subsequently known. Hence, the iris detection search can be executed on a small region between them. Because of the high contrast between the eyeball and the eye white, the eye image is easily segmented based on a threshold that was automatically selected from the histogram of the eye region. It is known that “opening” an image breaks narrow isthmuses. Hence, the morphological “open” operation is applied to separate the iris from the eyelid.

The gaze determination method relies on estimating the ellipse of the iris contour and by projective geometry. This leads to two surface normal solutions. In order to discard the false normal, the anthropomorphic ratio of the eyeball radius to the iris circle radius is used.

From the observed perspective projection of a circle having known radius, it is possible to infer analytically the supporting plane on which the circle lies, as well as where the center of the circle lies. A unique solution can be inferred using the one circle algorithm.

The system defines the origin of the camera coordinate system to be at the lens center and let the Z-axis coincide with the optical axis of the camera. Then for a right-hand system, the Y- and X-axes are taken to be vertical and horizontal, respectively. Now, the distance between the two corners of an eye and the center of the eyeball should be equal to each other. Hence:

OₛP₁=OₛP₂

where Oₛᵢ is the center of the eyeball and P₁ and P₃ are the left and right eye corners, respectively.

Consider the iris contour Q. Let the two solutions for the surface normal of the plane of Q be denoted as n₁=(cos α₁, cos β₁, cos γ₁)^{T} n₂=(cos α₂, cos β₂, cos γ₂)^{T} and let the corresponding solutions of the center of the iris contour be denoted as O_{c1}(x₀₁,y₀₁,z₀₁) and O_{c1}(x₀₂,y₀₂,z₀₂) respectively. The center of the eyeball Oₛᵢ can be calculated by:

xₛᵢ=x₀ᵢ+d cos αₐ, yₛᵢ=y₀ᵢ+d cos βᵢ, zₛᵢ=z₀ᵢ+d cos γ

where i=1,2 and d is the distance from the center of the eyeball to the iris plane:

d=\sqrt{R²−r²}=r\sqrt{c²−1}

and c is a constant.

Subsequently, the solutions of the two eye corners are projected to the gaze camera coordinate system. The distances between the center of the eyeball and the two eye corners are compared. If:

|Oₛ₁P₁−Oₛ₁P₃|≦|Oₛ₂P₁−Oₛ₂P₃|

then (n₁, O_{c1}) is the desired solution, otherwise (n₂, O_{c2}) is the solution.

If a subject's gaze is determined to be within the confines of the overhead display for some predefined number of consecutive video frames, the system concludes that the subject has placed their attention on the display. Consequently, demographic information of the subject is extracted using a skin detection and analysis approach.

Human skin tones form a special category of colors, distinctive from the colors of most other natural objects. Although skin colors differ from person to person, and race to race, they are distributed over a very small area on the chrominance plane. This means that skin colors are relatively consistent in hue and saturation. The major difference between skin tones is the intensity, represented by the luminance (Y). For skin color determination, we propose training on the luminance distributions of known skin colors from a variety of ethnicities. When a novel subject is introduced to the system the image of their face will first be converted into the YCbCr color space. Image pixels whose Cb and Cr color components are within the typical skin color range are considered to be pixels containing skin. From these pixels, the subject's skin intensity (represented by the Y component) will be compared to known intensity samples enrolled in the system's database. The ethnicity that most closely matches the subject will be determined to be the subject's ethnicity.

A GPS tracking device, as is commonly known, will be incorporated as part of media unit assembly 10. The GPS tracking device will add information as to where the operator is and, added to the automatic gaze detection algorithm, will determine the most ideal locations for future advertising. This information will be written to a database, and then given to advertising customers as feedback at a later time.

The GPS component will also provide security in recovering the device in case of theft. The GPS tracker will be installed anywhere on media unit assembly 10. The GPS tracker is preferably placed on or within electronics casing 22. The GPS tracker can also be used to monitor the device's location during usage. For example, if a customer would like to check if their advertisements are being displayed in the geographical locations they intended, they can use a web-based tool that can tell them the precise location of the device, with an update every few minutes when the advertisements are displayed on video display 48.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

2. A system for conveying visual messages comprising:
a. a media unit with an electronic video display of at least about 12 inch width having an input for receiving video display information and a surface for viewing video from said input;
b. a support for said video display;
c. a harness connected to said support suitable for wearing by a standing or walking person;
d. a source of electricity for said video display;
wherein said display is viewable from a distance at least 10 feet from said display.

3. The system of claim 1 wherein said video display is CRT, LCD, plasma OLED, or any combination thereof.

4. The system of claim 1 wherein said input for receiving video display information is stored on a computer readable medium.

5. The system of claim 1 wherein said input for receiving video display information is transmitted wirelessly to said video display.

6. The system of claim 1 wherein said input for receiving video display information receives video display input and transforms said input into a visual image viewable on said video display.

7. The system of claim 1 wherein said support extends upward from said harness.

8. The system of claim 1 wherein said support holds said video display between about 6-10 feet above the ground.

9. The system of claim 1 wherein said harness is worn on the upper torso of a wearer.

10. The system of claim 1 wherein said harness is worn on the shoulder of a wearer.

11. The system of claim 1 wherein said source of electricity is a battery.

12. The system of claim 1 wherein said source of electricity is from solar power.

13. The system of claim 1 wherein said system weighs less than about 100 pounds.

14. The system of claim 1 wherein said system weighs less than about 75 pounds.

15. The system of claim 1 wherein said media unit further includes a camera for tabulating information relating to the number of persons viewing said video display.

16. A method of advertising comprising:
a. connecting a media unit with a video display of at least about 12 inch width having an input for receiving video display information and a surface for viewing video from said input to a support;
b. connecting said support to a wearable harness;
c. placing the harness on a wearer;
d. initiating input to said video display such that input generates images on said video display;
e. having a wearer stand or walk such that said video display on said support is about 6-10 feet above the ground.

16. The method of claim 15 wherein said media unit further includes a camera.

17. The method of claim 16 wherein said camera is operatively connected to a computer and wherein said camera and computer record information relating to persons viewing said images on said video display.

18. The method of claim 15 wherein said harness has legs that support the unit when unharnessed from a person.

19. The method of claim 15 wherein said video display is generated from information stored on computer readable media on said display unit or transmitted wirelessly to said display unit.
